(19) United States
(12) Patent Application Publication
(10) Pub. No.: US 2025/0086683 A1
(43) Pub. Date: Mar. 13, 2025

(54) System and Method for Supporting Multiple Public Cloud Marketplace Listings with a Single Software Image

(71) Applicant: Dell Products L.P., Round Rock, TX (US)

(72) Inventors: Dmitry Krivenok, Dublin (IE); Alexandra Panina, Dublin (IE)

(21) Appl. No.: 18/464,750

(22) Filed: Sep. 11, 2023

(51) Int. Cl. G06Q 30/0601

(52) U.S. Cl. CPC G06Q 30/0601

(57) ABSTRACT

A method, computer program product, and computing system for integrating one or more public cloud marketplace listings with cloud metadata services. The method includes processing a selection of a public cloud marketplace listing for a cloud-based application from the one or more public cloud marketplace listings, where each public cloud marketplace listing includes a globally unique identifier and a cloned software image. The cloned software image includes a pricing model table that lists one or more pricing models and an associated globally unique identifier for each pricing model listed therein. The method further includes obtaining the globally unique identifier for the selected public cloud marketplace listing from the cloud metadata services, identifying a pricing model corresponding to the obtained globally unique identifier from the pricing model table, and performing a boot sequence of the cloned software image with the identified pricing model.

### BACKGROUND

Modern enterprise products sometimes rely on external software products in order to perform their primary function. In some instances, the external software is free, opensource, and requires no licensing of any kind. However, in most other instances, the external software is not free and some form of licensing and/or payment must be made before anything else can occur. Accordingly, marketplace listings are created to reflect a variety of licensing/payment models thereby giving the end user different options on how to proceed.

Increasing numbers of enterprise products are being provided as offerings in the public clouds such as Amazon Web Services (AWS®), Microsoft® Azure® and GCP®. One challenge in this process is integration with cloud marketplaces. This, in a majority of cases, requires creating and maintaining multiple marketplace listings to support different pricing models, charge customers differently depending on features, or comply with requirements of public clouds.

Each marketplace listing is going to have some product's software image associated with it for example, Amazon machine image (AMI) in the case of AWS. The software inside the image needs to understand what marketplace listing the computer instance was instantiated from in order to adjust the behavior and enable/disable certain functionality. For example, a product deployed from a bring your own license (BYOL) listing must support installation of the software license while the same product deployed from a pay as you go (PAYGO) listing normally needs to have licensing functionality disabled.

One approach to solve this problem is to build multiple images of the product, one for each cloud marketplace listing. In this case, all functionality may be adjusted at build time and the software will no longer need to care about which listing it was deployed from. However, this approach requires potentially significant changes to product build procedures, which in turn may lead to a proliferation of software images that increases build time and computing/storage resources, and extra quality analysis efforts.

Another less obvious issue is that, due to security reasons, public clouds like AWS do not allow software images in the marketplace unless they pass an automatic or semi-automatic security scan. If listings have different software images, this increases the overhead of security scanning, which includes addressing found issues and making it more difficult to negotiate security exceptions because this lengthy bureaucratic process must be done for each image separately.

### SUMMARY OF DISCLOSURE

In one example implementation, a computer-implemented method for integrating one or more public cloud marketplace listings with cloud metadata services, may include, but is not limited to processing a selection of a public cloud marketplace listing for a cloud-based application from the one or more public cloud marketplace listings, where each public cloud marketplace listing includes a globally unique identifier and a cloned software image. The cloned software image includes a pricing model table that lists one or more pricing models and an associated globally unique identifier for each pricing model listed therein. The method further includes obtaining the globally unique identifier for the selected public cloud marketplace listing from the cloud metadata services, identifying a pricing model corresponding to the obtained globally unique identifier from the pricing model table, and in response to identifying the obtained globally unique identifier in the pricing model table, performing a boot sequence of the cloned software image with the identified pricing model.

One or more of the following example features may be included. The globally unique identifier may be allocated for each public cloud marketplace identifier before the public cloud marketplace listing is created. The globally unique identifier may be a product code associated with a respective public cloud marketplace listing. A common base image may be used for each cloned software image such that cloning the software image cannot modify the product code. Cloud-based application behavior may be adjusted using the pricing model by at least one of: reading a persisted value directly from the pricing model table; and sending a query to the cloud metadata service via an application programming interface (API). In response to not identifying a corresponding globally unique identifier, a boot sequence may be cancelled. In response to identifying an unaffiliated globally unique identifier that does not correspond to any of the one or more pricing models, a boot sequence may be cancelled.

In another example implementation, a computer program product residing on a non-transitory computer-readable medium may include, but is not limited to one or more public cloud marketplace listings with cloud metadata services, where each public cloud marketplace listing includes a globally unique identifier and a cloned software image. The cloned software image may include a pricing model table that lists one or more pricing models and an associated globally unique identifier for each pricing model listed therein. A plurality of instructions stored on the non-transitory computer-readable medium which, when executed by a processor, cause the processor to perform operations, that may include, but is not limited to obtaining the globally unique identifier for the selected public cloud marketplace listing from the cloud metadata services, identifying a pricing model corresponding to the obtained globally unique identifier from the pricing model table, and in response to identifying the obtained globally unique identifier in the pricing model table, performing a boot sequence of the cloned software image with the identified pricing model.

One or more of the following example features may be included. The globally unique identifier may be allocated for each public cloud marketplace identifier before the public cloud marketplace listing is created. The globally unique identifier may be a product code associated with a respective public cloud marketplace listing. A common base image may be used for each cloned software image such that cloning the software image cannot modify the product code. Cloud-based application behavior may be adjusted using the pricing model by at least one of: reading a persisted value directly from the pricing model table; and sending a query to the cloud metadata service via an application programming interface (API). In response to not identifying a corresponding globally unique identifier, a boot sequence may be cancelled. In response to identifying an unaffiliated globally unique identifier that does not correspond to any of the one or more pricing models, a boot sequence may be cancelled.

In another example implementation, a system for integrating one or more public cloud marketplace listings with cloud metadata services, may include, but is not limited to one or more public cloud marketplace listings with cloud metadata services, where each public cloud marketplace listing includes a globally unique identifier and a cloned software image. The cloned software image may include a pricing model table that lists one or more pricing models and an associated globally unique identifier for each pricing model listed therein. A processor may be configured to: obtain the globally unique identifier for the selected public cloud marketplace listing from the cloud metadata services, identify a pricing model corresponding to the obtained globally unique identifier from the pricing model table, and in response to identifying the obtained globally unique identifier in the pricing model table, perform a boot sequence of the cloned software image with the identified pricing model.

One or more of the following example features may be included. The globally unique identifier may be allocated for each public cloud marketplace identifier before the public cloud marketplace listing is created. The globally unique identifier may be a product code associated with a respective public cloud marketplace listing. A common base image may be used for each cloned software image such that cloning the software image cannot modify the product code. Cloud-based application behavior may be adjusted using the pricing model by at least one of: reading a persisted value directly from the pricing model table; and sending a query to the cloud metadata service via an application programming interface (API). In response to not identifying a corresponding globally unique identifier, a boot sequence may be cancelled. In response to identifying an unaffiliated globally unique identifier that does not correspond to any of the one or more pricing models, a boot sequence may be cancelled.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a data ownership process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the single image listing process of FIG. 1 according to one or more example implementations of the disclosure;

FIG. 4 is an example diagrammatic view of a public marketplace according to one or more example implementations of the disclosure;

FIG. 5 is an example diagrammatic view of the one or more listings according to one or more example implementations of the disclosure; and

FIG. 6 is an example diagrammatic view of a single software image according to one or more example implementations of the disclosure.

Like reference symbols in the various drawings indicate like elements.

### DETAILED DESCRIPTION

### System Overview:

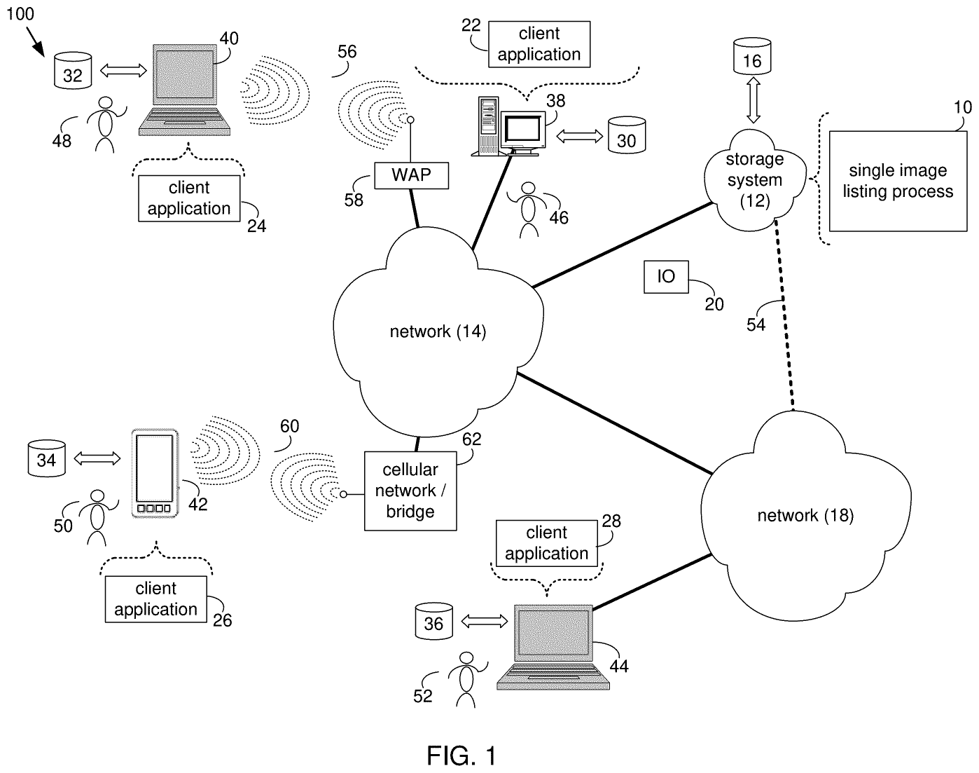

Referring to FIG. 1, there is shown single image listing process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of single image listing process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of single image listing process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

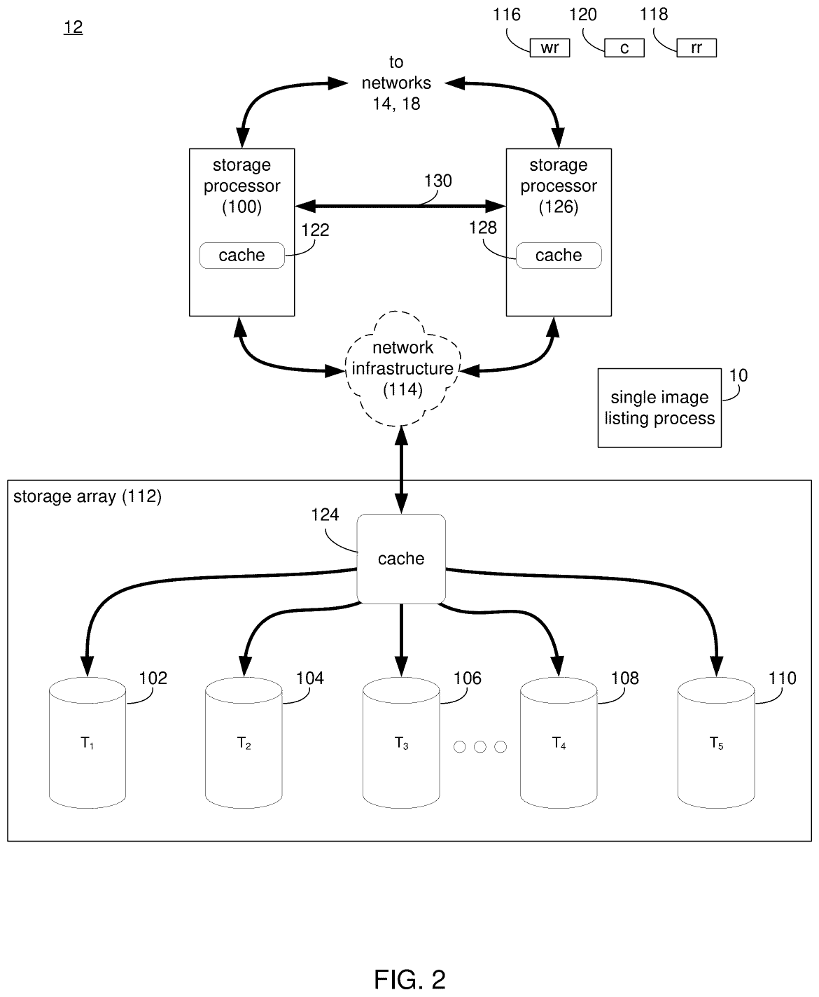

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of single image listing process 10. The instruction sets and subroutines of single image listing process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of single image listing process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of single image listing process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of single image listing process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of single image listing process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of single image listing process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### The Single Image Listing Process:

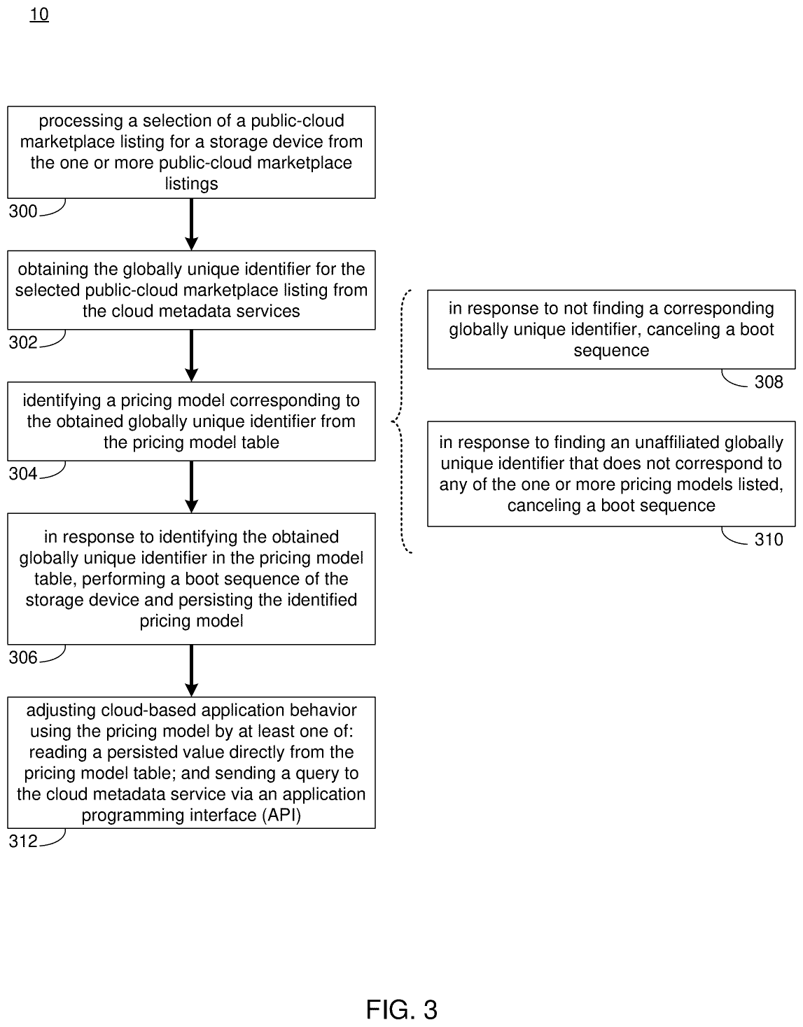

Referring also to FIGS. 3-6 and in some implementations, single image listing process 10 may process 300 a selection of a public cloud marketplace listing for a cloud-based application from the one or more public cloud marketplace listings, wherein each public cloud marketplace listing includes a globally unique identifier and a cloned software image including a pricing model table that lists one or more pricing models and an associated globally unique identifier for each pricing model listed therein. The globally unique identifier may be obtained 302 for the selected public cloud marketplace listing from the cloud metadata services, and a pricing model corresponding to the obtained globally unique identifier may be identified 304 from the pricing model table. In response to identifying the obtained globally unique identifier in the pricing model table, a boot sequence of the cloned software image is performed 306 with the identified pricing model.

In some implementations, single image listing process 10 may allow for use of a single software image with multiple public cloud marketplace listings. Using a single software image reduces the overhead of building multiple images and passing security scans on all of them. For example, single image listing process 10 is based on a technique that guarantees that globally unique identifier cannot be spoofed and thereby ensuring that the pricing model will be properly derived within the compute instance at runtime. Additionally, single image listing process 10 may enable full end-to-end testing of the cloud-based application 506 before the marketplace listing becomes fully available. Accordingly, single image listing process 10 may encapsulate all logic related to marketplace integration and communication with metadata servers in one place and may provide a simple interface for the rest of the software stack to query the derived pricing model and adjust software behavior based on it.

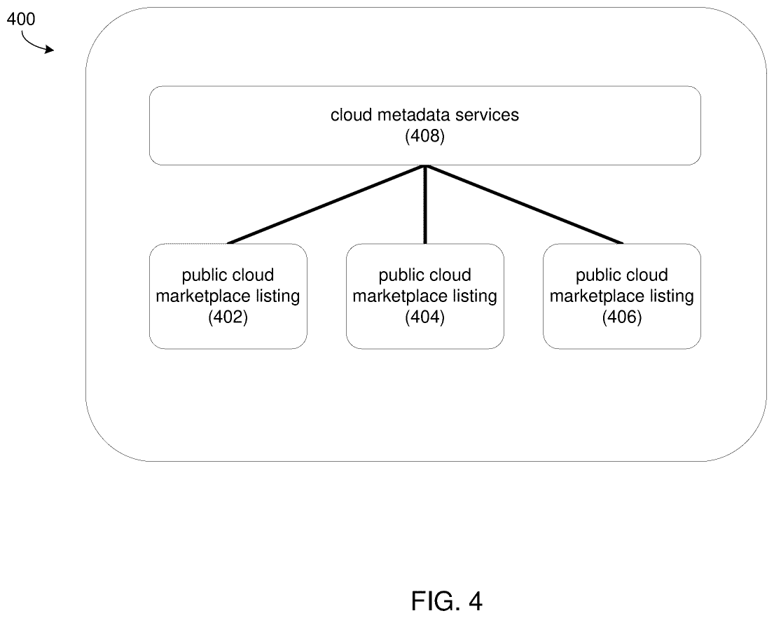

In some implementations, single image listing process 10 begins by processing 300 a selection of a public cloud marketplace listing for a cloud-based application from one or more public cloud marketplace listings. Referring also to FIG. 4, a public cloud marketplace (e.g., public cloud marketplace 400) may include a virtual store created by enterprise cloud-based application providers for end users to gain access to cloud-based resources in the form of one or more public cloud marketplace listings (e.g., public cloud marketplace listings 402, 404, 406). In some implementations, each public cloud marketplace listing (e.g., public cloud marketplace listings 402, 404, 406) is a unique instance of a software image that may be configured to perform a specific usage.

For example, each of listing 402, 404, 406 represents a specific licensing scheme/mode of payment. In one example, one instance (e.g., public cloud marketplace listing 402) may be configured to unlock every feature of software A for an unlimited period of time. This is commonly known as a “bring your own license” (BYOL) licensing scheme, because the user already owns a software license. For BYOL a full version of software A is installed on that instance. There is generally no need to monitor which features are used or how long software A is used, because the user has already paid for the right to use every feature. The instance settings are configured in advance in anticipation of BYOL usage.

In another example, a different public cloud marketplace instance (e.g., public cloud marketplace instance 404) may be configured to only provide features up to a certain tier, or for a limited amount of time. This is generally known as a “pay as you go” (PAYGO) licensing scheme, because the user shows up with nothing and may only access what they pay for. For PAYGO only, the features of the selected tier are provided, which means a more limited version of software A may need to be installed, and some form of usage monitoring may be enabled to keep track of which features are used and how long they are used for. Here, the instance settings are configured in advance in anticipation of PAYGO usage.

In some implementations, public cloud marketplace 400 may include cloud metadata services (e.g., cloud metadata services 408) that may be configured to dynamically communicate marketplace metadata to cloud instances instantiated from corresponding listings (e.g., public cloud marketplace listing/instance 402, 404, 406). Cloud metadata services 408 is a feature built-into public cloud marketplace 400 to allow users to access data and to perform data integration such as analysis, modeling, cleansing, and transformation. In some implementations, cloud metadata services 408 may play a critical role in determining which licensing scheme/payment model should be used at runtime for a given marketplace listing as will be discussed further below. For example, single image listing process 10 may obtain 302 a globally unique identifier for a particular public cloud marketplace listing from the cloud metadata services. In this manner, cloud metadata services 408 is able to access a globally unique identifier for a given public cloud marketplace listing (e.g., public cloud marketplace listings 402, 404, 406).

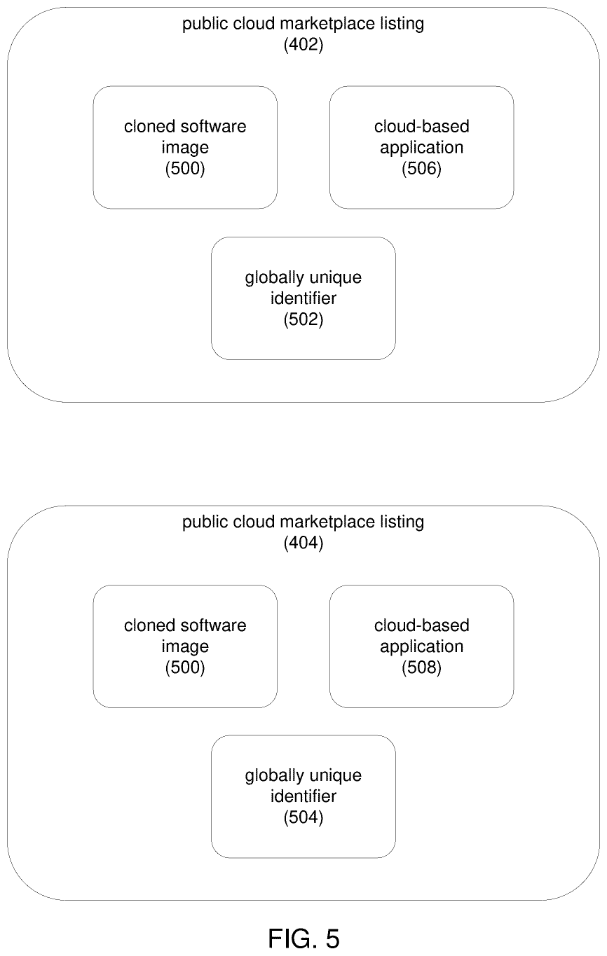

Referring also to FIG. 5, each public cloud marketplace listing (e.g., public cloud marketplace listings 402, 404) may include a cloned software image (e.g., cloned software image 500) and a globally unique identifier (e.g., globally unique identifier 502 for public cloud marketplace listing 402 and globally unique identifier 504 for public cloud marketplace 404). As discussed above, cloned software image 502 may be a unique instance of a common or identical software image that is configured to perform a specific usage. As shown in FIG. 5, cloned software image 500 is present in both public cloud marketplace listing 402, 404. In the context of public cloud marketplace listings, each public cloud marketplace listing is actually an instance of a software image that has been pre-configured to facilitate use of software under a particular pricing model, such as BYOL, or PAYGO.

Single image listing process 10 leverages particular properties of public cloud environments to provide a reliable, isolated and secure means of determining the underlying cloud marketplace listing at runtime. For example, public clouds support globally unique marketplace listing identifiers which may be allocated for a new marketplace listing before the listing is created. For example, in AWS, each listing has a product code which does not change, even for new versions of the software image within the public cloud marketplace listing. In some implementations, public clouds support a mechanism to obtain the public cloud marketplace product code reliably and securely at runtime.

Public cloud marketplace listings/instances, like cloned software image 500, may interact with instance metadata servers (e.g., AWS international material data system IMDSv2) to provide instance-specific information, including the product code of the software image the instance was instantiated from. In some implementations, the product code cannot be spoofed because communication between the instance and the metadata server is secure. For example, in AWS, the instance “talks” to a local metadata cache inside a virtual private network (VPN) nitro card, (i.e., which makes communication localized to the physical host). This improves the reliability of the mechanism because there is no remote communication and no possibility of network failure. Public cloud guarantees that cloning of the software image will not change or remove the product code. As such, public cloud marketplace listing 402 and public cloud marketplace 404 may each use the “unspoofable” product code as a globally unique identifier (e.g., globally unique identifier 502 for public cloud marketplace listing 402 and globally unique identifier 504 for public cloud marketplace listing 404).

In some implementations, single image listing process 10 may dynamically determine the pricing model of a cloud-based application (e.g., cloud-based application 506 running in public cloud marketplace listing 402 and cloud-based application 508 running in the public cloud marketplace listing 404). This can be done in exactly one place in the software stack and the rest of the software may just rely on a derived pricing model. This allows for the encapsulation of cloud-specific logic in one place (i.e., the software image) and provides a common interface (local metadata cache) to upper layers of the software stack.

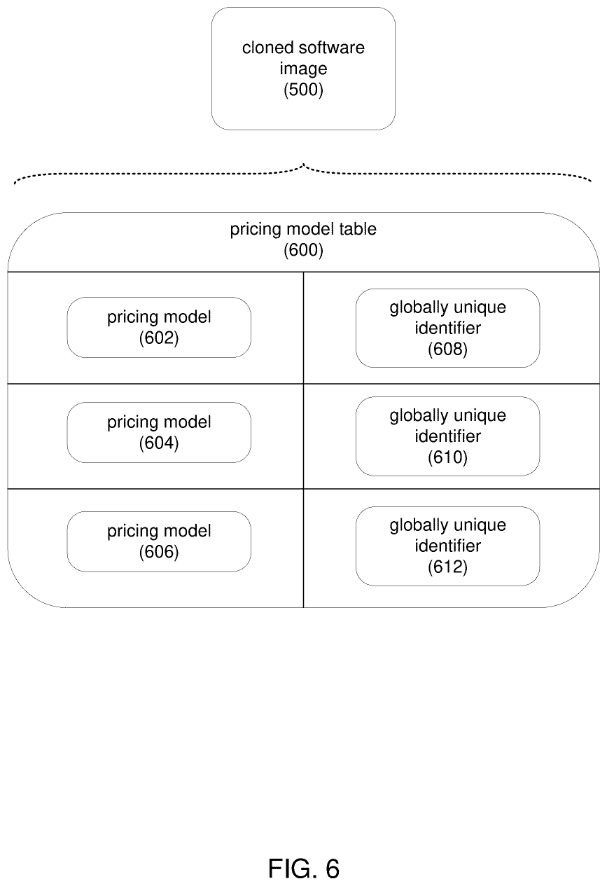

As shown in FIG. 6, cloned software image 500 may include a pricing model table (e.g., pricing model table 600) that lists one or more pricing models (e.g., pricing models 602, 604, 606) and an associated globally unique identifier (e.g., globally unique identifier 608 for pricing model 602; globally unique identifier 610 for pricing model 604; globally unique identifier 612 for pricing model 606) for each pricing model listed therein. In some implementations, pricing model table 600 contains static pricing decided ahead of time for each pricing model included. In some implementations, pricing model table 600 is changed when a new public cloud marketplace listing is added, or when a public cloud marketplace listing is removed. As stated before, each listing includes an “unspoofable” product code that may be used as globally unique identifier (e.g., globally unique identifier 502 for public cloud marketplace listing 402 and globally unique identifier 504 for public cloud marketplace listing 404).

In some implementations, single host listing process 10 obtains 302 the globally unique identifier for the selected public cloud marketplace listing from the cloud metadata services 402 (see FIG. 4). When the instance/cloned software image 600 boots, it automatically communicates with cloud metadata services 402 via a cloud specific application programming interface (API) and obtains 302 the product code/globally unique identifier.

In some implementations, single host listing process 10 identifies 304 a pricing model (e.g., pricing model 602, 604, 606) corresponding to the obtained globally unique identifier (e.g., globally unique identifier 502 for public cloud marketplace listing 402; and globally unique identifier 504 for public cloud marketplace listing 404 from pricing model table 600). Identifying 304 a corresponding pricing model may be achieved by cross-referencing the obtained globally unique identifier with the one or more globally unique identifiers (e.g., globally unique identifiers 608, 610, 612) listed in pricing model table 600.

In some implementations, in response to identifying 304 the obtained globally unique identifier in the pricing model table, single host listing process 10 performs 306 a normal boot sequence of the cloned software image (e.g., cloned software image 500) with the identified pricing model. In some implementations, after the public cloud marketplace listing selection is made, the desired cloud-based application (e.g., cloud-based application 506 on public cloud marketplace listing 402 and cloud-based application 508 on public cloud marketplace listing 404) will start running, and all of the settings for the associated pricing model will already be in place because the correct software instance was used.

In some implementations, in response to not identifying a corresponding globally unique identifier, single host listing process 10 cancels 308 a boot sequence and provides a failure notification. In this case, a failure condition has occurred, but the underlying reason is unclear. All that is known for certain, is that no corresponding globally unique identifier was found. In one example, there may be an issue with cloned software image 500. In another example, there may be an issue with pricing model table 600.

In some implementations, in response to identifying an unaffiliated globally unique identifier that does not correspond to any of the one or more pricing models listed, single host listing process 10 cancels 310 a boot sequence and provides a failure notification. In this case, a failure condition has occurred, but the underlying reason is better understood than the case when a globally unique identifier is not identified. For example, cloned software image 500 may be related to the problem, because while a globally unique identifier is found, it is not the globally unique identifier that was expected.

Consider the following example of one cloud-based application that has three public cloud marketplace listings. Each public cloud marketplace listing has an associated product code that is known beforehand, and those product codes are unique in the entire cloud space. Moreover, each listing is using the same software image (e.g., cloned software image 500) as illustrated in Table 1 below.

TABLE 1

| | $/hour | Product | Image |
|---|---|---|---|
| Listing | (software cost) | Code | ID |
| BYOL | $0 | XXX | ABC |
| PAYGO (standard) | $1 | YYY | ABC |
| PAYGO (high availability) | $1.50 | ZZZ | ABC |

Inside each software image, a static product code-to-pricing model is shown as follows in Table 2, based the example above.

TABLE 2

| Product Code | Pricing Model |
|---|---|
| XXX | BYOL |
| YYY | PAYGO |
| ZZZ | PAYGO |

If the product code is not found in the table, then this is an error, and the service fails the boot of the system providing a meaningful error message to the user or administrator. If the product code is found in the table, then it persists the associated pricing model in a file or system registry. In some implementations, single image listing process 10 may provide an API to query (e.g., via a protocol such as representational state transfer (REST)). In some implementations, if the product code is found in the table, but the associated pricing model is not the same as the already persisted one, then this is an error, and the service fails the boot.

By only allowing for these possibilities, single image listing process 10 may guarantee that either the boot will fail if unexpected data was received, or that the instance/cloned software image 500 will have exactly one pricing model from the moment it first boots up.

In some implementations, a common base image is used for each cloned software image such that cloning the software image cannot modify the product code. For example, single image listing process 10 may a separate, but identical software image (e.g., cloned software image 500) for each public cloud marketplace listing (e.g., public cloud marketplace listings 402, 404, 406). Restricting the process to one software image means that there will only be one software image to build, one image to qualify, and only one image to run security scans against. In other words, single image listing process 10 avoids creating redundant work. Further, the public cloud guarantees that cloning of the software image will not change or remove the product code.

In some implementations, single image listing process 10 adjusts 312 cloud-based application behavior using the pricing model may be implemented by at least one of: reading a persisted value directly from the pricing model table, and sending a query to the cloud metadata service via an application programming interface (API). Under ideal circumstances, cloned software image 500 will only boot up if there are no issues and no adjustments need to be made. However, if after some initial use, the user were to wish for a different pricing model, single image listing process 10 adjusts 312 cloud-based application behavior by either directly reading from pricing model table (e.g., pricing model table 600) or by sending a query to cloud metadata services 408 via an API.

In some implementations, the cloud-based application (e.g., cloud-based application 506 on public cloud marketplace listing 402 and cloud-based application 508 on public cloud marketplace listing 404) is deployed in a test environment and the globally unique identifier (e.g., globally unique identifier 502 for public cloud marketplace listing 402 and globally unique identifier 504 for public cloud marketplace 404) can be modified by a user. For example, product testing is a benefit of single image listing process 10, because it allows for end-to-end testing before a cloud-based application is made available in the public cloud marketplace.

There may be various ways to accomplish end-to-end testing. In one example, when a cloud-based application (e.g., cloud-based application 506) is deployed in a test environment, a tester may deploy it with a user-data section containing a user defined product code, which is known before the public cloud marketplace listing exists. In some implementations, cloud metadata services 402 may use this value instead of the product code. The rest of the code would not change at all for testing. In another example, it is possible to have a middleware/proxy sitting between cloud-based application 506 and cloud metadata services 402. When cloud-based application 506 is deployed in a test cloud account, the proxy may be configured to append a predefined product code to the instance metadata which is going to be read by cloud metadata services 402. In both cases, the number of changes is minimal, and it enables end-to-end testing of product functionality.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method for integrating one or more public cloud marketplace listings with cloud metadata services, comprising:
processing a selection of a public cloud marketplace listing for a cloud-based application from the one or more public cloud marketplace listings, wherein each public cloud marketplace listing includes a globally unique identifier and a cloned software image, the cloned software image including a pricing model table that lists one or more pricing models and an associated globally unique identifier for each pricing model listed therein;
obtaining the globally unique identifier for the selected public cloud marketplace listing from the cloud metadata services;
identifying a pricing model corresponding to the obtained globally unique identifier from the pricing model table; and
in response to identifying the obtained globally unique identifier in the pricing model table, performing a boot sequence of the cloned software image with the identified pricing model.

2. The computer-implemented method of claim 1, wherein the globally unique identifier is allocated for each public cloud marketplace identifier before the public cloud marketplace listing is created.

3. The computer-implemented method of claim 1, wherein the globally unique identifier is a product code associated with a respective public cloud marketplace listing.

4. The computer-implemented method of claim 3, wherein a common base image is used for each cloned software image such that cloning the software image cannot modify the product code.

5. The computer-implemented method of claim 1, further comprising:
adjusting cloud-based application behavior using the pricing model by at least one of:
reading a persisted value directly from the pricing model table; and
sending a query to the cloud metadata service via an application programming interface (API).

6. The computer-implemented method of claim 1, further comprising:
in response to not identifying a corresponding globally unique identifier, canceling a boot sequence.

7. The computer-implemented method of claim 1, further comprising:
in response to identifying an unaffiliated globally unique identifier that does not correspond to any of the one or more pricing models, canceling a boot sequence.

8. A computer program product residing on a non-transitory computer readable storage medium having a plurality of instructions stored thereon which, when executed across one or more processors, causes at least a portion of the one or more processors to perform operations comprising:
processing a selection of a public cloud marketplace listing for a cloud-based application from the one or more public cloud marketplace listings, wherein each public cloud marketplace listing includes a globally unique identifier and a cloned software image, the cloned software image including a pricing model table that lists one or more pricing models and an associated globally unique identifier for each pricing model listed therein;
obtaining the globally unique identifier for the selected public cloud marketplace listing from the cloud metadata services;
identifying a pricing model corresponding to the obtained globally unique identifier from the pricing model table; and
in response to identifying the obtained globally unique identifier in the pricing model table, performing a boot sequence of the cloned software image with the identified pricing model.

9. The computer program product of claim 8, wherein the globally unique identifier is allocated for each public cloud marketplace identifier before the public cloud marketplace listing is created.

10. The computer program product of claim 8, wherein the globally unique identifier is a product code associated with a respective public cloud marketplace listing.

11. The computer program product of claim 10, wherein a common base image is used for each cloned software image such that cloning the software image cannot modify the product code.

12. The computer program product of claim 8, wherein the operations further comprise:
adjusting cloud-based application behavior using the pricing model by at least one of:
reading a persisted value directly from the pricing model table; and
sending a query to the cloud metadata service via an application programming interface (API)

13. The computer program product of claim 8, wherein the operations further comprise:
in response to not identifying a corresponding globally unique identifier, canceling a boot sequence.

14. The computer program product of claim 8, wherein the operations further comprise:
in response to identifying an unaffiliated globally unique identifier that does not correspond to any of the one or more pricing models, canceling a boot sequence.

15. A computing system including one or more processors and one or more memories configured to perform operations comprising:
processing a selection of a public cloud marketplace listing for a cloud-based application from the one or more public cloud marketplace listings, wherein each public cloud marketplace listing includes a globally unique identifier and a cloned software image, the cloned software image including a pricing model table that lists one or more pricing models and an associated globally unique identifier for each pricing model listed therein;
obtaining the globally unique identifier for the selected public cloud marketplace listing from the cloud metadata services;
identifying a pricing model corresponding to the obtained globally unique identifier from the pricing model table; and
in response to identifying the obtained globally unique identifier in the pricing model table, performing a boot sequence of the cloned software image with the identified pricing model.

16. The computing system of claim 15, wherein the globally unique identifier is allocated for each public cloud marketplace identifier before the public cloud marketplace listing is created.

17. The computing system of claim 15, wherein the globally unique identifier is a product code associated with a respective public cloud marketplace listing.

18. The computing system of claim 17, wherein a common base image is used for each cloned software image such that cloning the software image cannot modify the product code.

19. The computing system of claim 15, wherein the processor is further configured to:
adjust cloud-based application behavior using the pricing model by at least one of:
reading a persisted value directly from the pricing model table; and
sending a query to the cloud metadata service via an application programming interface (API)

20. The computing system of claim 15, wherein the processor is further configured to:
in response to not identifying a corresponding globally unique identifier, cancel a boot sequence.
